(19) United States
(12) Patent Application Publication
(10) Pub. No.: US 2011/0030833 A1
(43) Pub. Date: Feb. 10, 2011

(54) JOINT SYSTEM FOR JOINING ENDS OF PANELS MADE OF INSULATED MATERIAL

(75) Inventor: Luciano Griggio, Ronchi di Villafranca Padovana (IT)

Correspondence Address: HUSCH BLACKWELL LLP, 190 Carondelet Plaza, Suite 600, ST. LOUIS, MO, 63105, US

(73) Assignee: P3 S.R.L., Ronchi di Villafranca Padovana (IT)

(21) Appl. No.: 12/739,472

(22) PCT Filed: Sep. 1, 2008
(86) PCT No.: PCT/EP08/07213

§ 371 Date: Sep. 20, 2010

(30) Foreign Application Priority Data
Oct. 24, 2007 (EP) 07425669.4

(51) Int. Cl. F16L 9/14; F16L 9/00; B23P 19/00

(52) U.S. Cl. 138/149; 138/177; 29/428

(57) ABSTRACT

It is illustrated a joint system (1; 1′) for joining end portions (2; 2′) of at least one panel (3; 3′) made of pre-insulated material comprising a joining device (4; 4′; 4″) provided, at opposite parts of a longitudinal centreline plane (π) of the same, with a first (5; 5′; 5″) and a second (6; 6′; 6″) longitudinal seat, each of said seats (5; 5′; 5″, 6; 6′; 6″) being adapted to house one of said end portions (2; 2′) of said at least one panel (3; 3′), said joining device (4; 4′; 4″) comprising means (8; 8′; 8″) for being fixed to the panel (3; 3′) adapted to be engaged in a removable manner with respective fixing countermeans associated with said at least one panel (3; 3′). There are furthermore illustrated a joining means (4; 4′; 4″), a panel (3; 3′) and a duct (15; 15′) for air-conditioning systems obtained therefrom, a method for manufacturing panels (3; 3′), a method for joining the end portions (2; 2′) of panels (3; 3′) made of pre-insulated material, as well as a method for manufacturing ducts (15; 15′) for air-conditioning systems.

### BACKGROUND OF THE INVENTION

The present invention refers to a joint system for joining the ends of panels made of pre-insulated material.

In particular, the present invention concerns a joint system for joining the ends of panels made of pre-insulated material used for manufacturing ducts for ventilation, heating and air-conditioning systems.

Furthermore, the present invention concerns a method of manufacturing ducts comprising such panels.

### RELATED ART

The use of pre-insulated panels for manufacturing air-conditioning, ventilation and heating systems is widely known in the field.

In the present context, the term “pre-insulated panel” is intended to indicate a composite panel provided with an insulating material before the panel is mounted to form ducts or in any case before being used.

Generally, insulated panels, suitably cut and assembled, are used to form ducts for transporting air at a medium/low pressure and at a low rate.

Currently, said ducts are made by glueing end portions of several pre-insulated panels. In some cases the ducts are formed by a single panel whereon weakening lines are suitably performed.

In the present context, the term “weakening line” indicates a line obtained by removing material by means of partial cutting, that is a cut that does not cross the entire thickness of the panel, but is made starting from one of its faces up to a predetermined depth which is smaller than the thickness of the panel.

The panel is then bent at such weakening lines and its ends are glued in such a manner to form a duct.

Subsequently, it is possible to support the glueing with adhesive tapes applied at the glued ends.

Such known techniques have several drawbacks. Foremost, it should be born in mind that, once applied, the glueing agent requires drying time. Not only does this imply greater times of manufacture of the ducts, but also increases difficulties when aligning the panels alongside and the possibility of losing, during the processing period, the alignment attained.

Another drawback of such known techniques regards the irreversibility of the chemical type of fixing in that once the ends of the panels are glued, it is no longer possible to disassemble the duct thus obtained in order to obtain the panels once again, for example in case of maintenance operations or in case of poor alignment at the end of the drying time, unless the same are cut and thus making them useless.

In addition, such techniques often have problems of low pneumatic and hydraulic tightness due to poor alignment of the panels. For this reason silicon materials are often used to reduce, such defects. However, there are cases wherein poor alignment defects cannot be rectified at all.

Lastly, in case of ducts arranged adjacent to walls, floors or ceilings, difficulties regarding the application of the adhesive tape might arise.

Therefore, the present invention has the object of providing a joint system for joining the ends of panels made of pre-insulated material capable of overcoming at least partially the abovementioned drawbacks.

Another object of the present invention is to provide a method of joining panels made of pre-insulated material and a method of manufacturing ducts free from the abovementioned drawbacks.

### SUMMARY OF THE INVENTION

According to the first aspect thereof, the invention refers to a joint system for joining the ends of panels made of pre-insulated material comprising:
a joining device provided, at opposite parts of a longitudinal centreline plane thereof, with a first and a second longitudinal seat, each of said seats being adapted to house one of said end portions of said at least one panel, said joining device comprising means for being fixed to the panel adapted to be engaged in a removable manner with respective fixing countermeans associated with said at least one panel.

Providing such joint system, it is possible to overcome the aforementioned drawbacks. In particular, such a type of system results to be simple, with good pneumatic and hydraulic tightness properties and applicable even in restricted spaces.

In the present context, the terms “longitudinal” and “radial” refer to the invention during use. In other words, the term “longitudinal” indicates the direction extending following the length of the panel or duct, while “radial” indicates the direction extending from the internal towards the external of the panel or duct.

Advantageously, said fixing countermeans comprise grooves, obtained at the end portions of the panel, adapted to be engaged in a removable manner with said fixing means of the joining device.

Preferably, said grooves are obtained in the thickness of the panel at the two opposite end portions.

According to a second aspect thereof, the invention regards a joining device for joining end portions of at least one panel made of pre-insulated material provided, at opposite parts of a longitudinal centreline of the same, with a first and second longitudinal seat, each of said seats being adapted to house one of said end portions of said at least one panel, said joining device comprising means for being fixed to the panel.

According to a preferred embodiment, said joining device comprises a radially internal shaped guide flap and a radially external shaped guide flap extended astride the longitudinal centreline plane of the joining device itself and connected to each other by at least a central body, said radially internal and external shaped guide flaps and said central body defining the first and the second seat housing the end portions of the panel.

Preferably, said radially internal shaped guide flap and a radially external shaped guide flap comprise two semi-portions of shaped guide flap, symmetrically arranged with respect to the longitudinal centreline plane and forming an angle α and β respectively with said longitudinal centreline plane.

Such angles α and β are substantially equal.

Preferably, both angle α and angle β are comprised in the range between 20° and 90°.

According to a preferred embodiment, said fixing means comprise at least two fixing flaps rigidly connected to said central body, such flaps forming an angle γ with said longitudinal centreline plane which is substantially equal to α and β.

Such angles α, β and γ define the relative positions of the two panels to be joined.

Preferably, said angle γ is comprised in the range between 20° and 90°.

Advantageously, the fixing flaps are substantially T-shaped.

According to one embodiment, the joining device is provided with housing means for an angular element, such means preferably comprise a cavity adapted for the insertion of said angular element.

Through such angular element, its is possible to connect two joining devices, whose longitudinal centreline planes π are not parallel to each other, when it is required by construction requirements.

In addition, the insertion of said angular element allows to strengthen the duct formed with such joining devices.

The joining device is preferably made of polymeric material and, in a particularly preferred manner, it is made of at least one of the following materials: polyvinyl chloride, nylon, polymeric material reinforced with reinforcement fibres.

Preferably, said polymeric material is a thermosetting material, and more preferably it is a thermosetting resin.

According to an alternative embodiment, said joining device is made of metallic material and, preferably, aluminium.

According to a third aspect thereof, the invention concerns a panel made of pre-insulated material for manufacturing a duct for air-conditioning systems comprising fixing countermeans adapted to be engaged in a removable manner with respective fixing means associated with a joining device, as described in the following.

Advantageously, said fixing countermeans comprise grooves, obtained at the end portions of the panel.

Preferably, said grooves are obtained in the thickness of the panel.

According to a preferred embodiment, the panel made of pre-insulated material comprises at least a weakening line adapted to facilitate the panel bending operation during the mounting thereof.

Advantageously, the panel comprises at least an external layer and an insulating layer and, preferably even an internal layer arranged in such a manner that the insulating layer is interposed between said external layer and said internal layer.

At least one among the external layer and the internal layer comprises aluminium.

The insulating layer comprises at least one of the materials selected from the group comprising: expanded polyurethane, expanded polyisocyanurate, phenolic foam, mineral wool.

According to a fourth aspect thereof, the invention concerns a duct for air-conditioning systems comprising:
at least one panel made of pre-insulated material as described in the following; and
at least one joining device as described in the following.

According to a fifth aspect thereof, the invention concerns a method of manufacturing panels made of pre-insulated material for manufacturing ducts for air-conditioning systems comprising the steps of:
providing at least one panel made of pre-insulated material;
providing the panel with fixing countermeans adapted to be engaged in a removable manner with respective fixing means associated with a joining device as described subsequently.

Preferably, this last step comprises the operation of performing grooves at end portions of the panel.

In addition, advantageously, the method comprises the step of performing at least one weakening line in the panel.

According to a sixth aspect thereof, the present invention concerns a method of joining the ends of the panels made of pre-insulated material comprising the steps of:
a. providing at least one panel made of pre-insulated material as described in the following;
b. nearing the end portions of said at least one panel and joining them by means of at least one joining device as described in the following.

According to a last aspect thereof, the invention regards a method of manufacturing a duct for air-conditioning systems comprising the steps of:
i. preparing at least one panel made of pre-insulated material as described in the following;
ii. nearing the end portions of said at least one panel and joining them by means of at least one joining device as described subsequently in such a manner to form a duct.

In such manner, it is possible to attain a method of joining panels and a method of manufacturing ducts which are simple, rapid, reversible and free from aligning and tightness problems.

Preferably, said method comprises, before step ii of nearing the end portions of said panel in such a manner to form a duct, even the step of suitably bending the panel following a bending direction transverse to the weakening lines, in case the latter are provided.

Advantageously, said method provides, before bending the panel, for the application of an amount of glueing agent at the bending lines, in such a manner to enhance the stability of the duct.

Other preferred characteristics of the joint system for joining ends of panels made of pre-insulated material, of the related method of joining the same, and of the method of manufacturing ducts according to the present invention are illustrated in the dependent claims whose content is herein enclosed for reference.

### BRIEF DESCRIPTION OF THE FIGURES

Features and advantages of the invention will be clear from the following description of some examples of preferred systems for joining the ends of the panels, of joining devices, of panels, of ducts made with the same and of the related methods of: manufacturing a panel, joining the ends of the panels and manufacturing ducts according to the invention, made—for illustrative and non-limiting purposes—with reference to the drawings attached wherein:

FIGS. 1a-1e show the steps of the method of manufacturing ducts according to a first embodiment of the invention, by means of using a joint system for joining the ends of the panel according to a first embodiment of the invention;

FIG. 2 shows a sectional view of a joining device of the joint system according to the first embodiment of the invention;

FIG. 3 shows a sectional view of a joining device of the joint system according to a second embodiment of the invention;

FIGS. 4a-4e show the steps of the method of manufacturing ducts according to a second embodiment of the invention, by means of a joint system for joining the ends of panels according to the second embodiment of the invention; and

FIGS. 5a and 5b respectively show perspective and sectional views of a joining device according to a third embodiment of the invention.

### DETAILED DESCRIPTION OF THE PREFERRED EMBODIMENTS

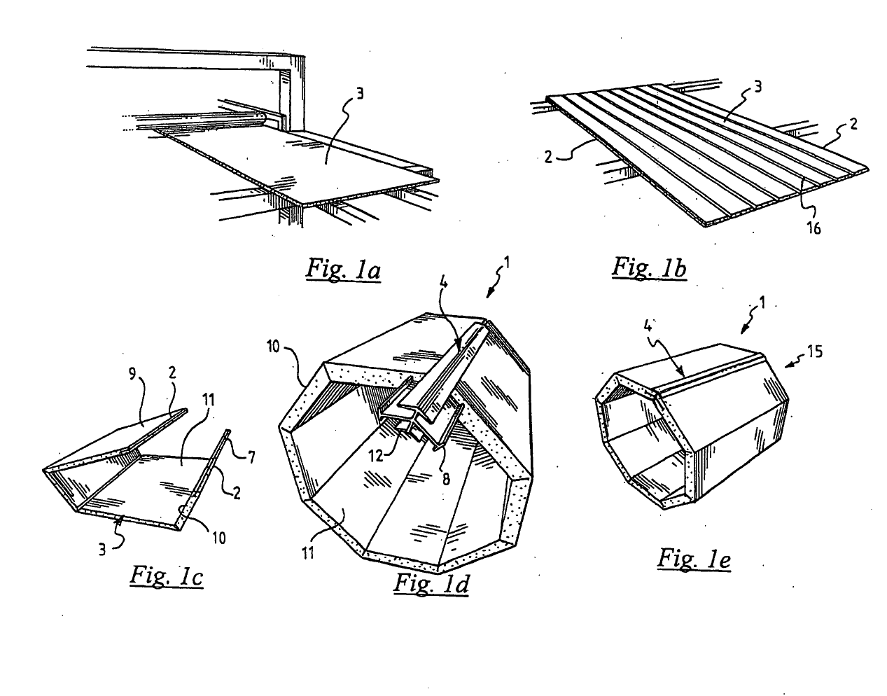

With reference to FIGS. 1a-1e, a joint system for joining end portions 2 of at least one panel 3 made of pre-insulated material, according to a first embodiment of the present invention, is entirely indicated by 1.

Such joint system 1 comprises a joining device 4 provided, at opposite parts of a longitudinal centre line plane π of the same, of a first 5 and a second 6 longitudinal seat. Each of said seats 5, 6 is adapted to house an end portion 2 of the panel 3. The joining device 4 also comprises means 8 for being fixed to the panel 3 adapted to be engaged in a removable manner with respective fixing countermeans associated with the panel 3.

According to such first embodiment, said fixing countermeans comprise grooves 7 made at the end portions 2 of the panel 3. Such grooves 7 are adapted to be engaged in a removable manner with said fixing means 8 of the joining device 4.

As shown in particular in FIG. 1c, said grooves 7 are obtained in the thickness of the panel.

The joining device 4 comprises a radially internal shaped guide flap 12 and a radially external shaped guide flap 13 extended astride the longitudinal centreline plane π of the joining device 4 itself. Such internal 12 and external 13 shaped guide flaps are connected to each other by at least one central body 14 in such a manner to define with the latter the first 5 and the second 6 seat for housing the end portions 2 of the panel 3.

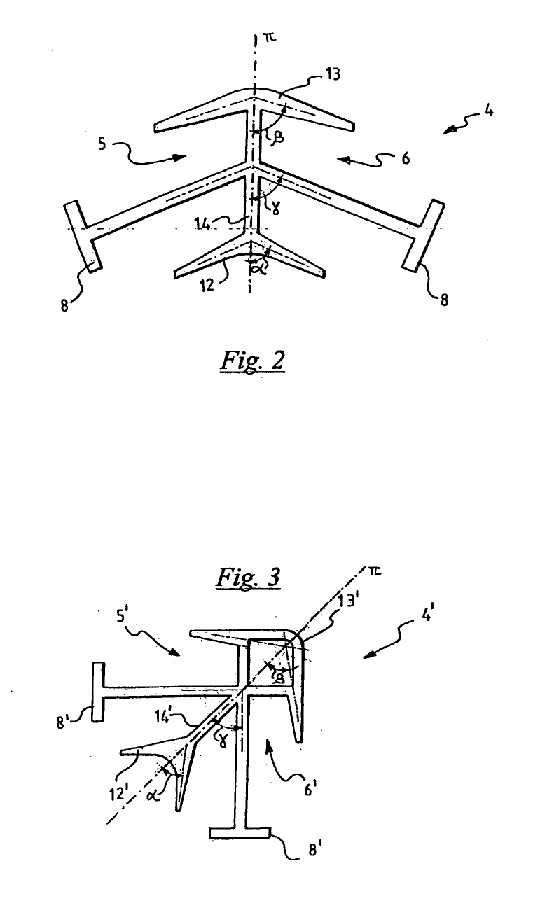

With special reference to FIG. 1d and also with reference to FIG. 2, it can be observed that the radially internal shaped guide flap 12 and the radially external shaped guide flap 13 comprise two semi-portions of a shaped guide flap, symmetrically arranged with respect to the longitudinal centreline plane π of the joining device 4 and respectively forming angles α and β with the same plane.

In other words, each semi-portion of a radially internal shaped guide flap 12 forms with the longitudinal centreline plane π an angle α, while each semi-portion of a radially external shaped guide flap 13 forms with the longitudinal centreline plane π an angle β.

Said angles α and β are substantially equal. In particular, they are both comprised in the range between 20° e 90°.

As observable in FIGS. 2, α and β are equal to approximately 67.5°.

The fixing means 8 comprise at least two fixing flaps rigidly connected to said central body 14, such fixing flaps forming with the longitudinal centreline plane π an angle γ which is substantially equal to αand β.

In particular, said angle γ is comprised in the range between 20° and 90°. And, in the first embodiment, it is equal to approximately 67.5°.

The aforementioned angles α, β and γ define the reciprocal position of the panels once the step of joining the same has been completed.

The fixing flaps are substantially T-shaped and, analogously, the grooves 7 obtained in the panel 3, adapted to house such flaps, have a T-section.

The joining device 4 is made of polymeric material and, preferably, it is made of at least one among the following materials: polyvinyl chloride, nylon, polymeric material reinforced with reinforcement fibres.

In case such joining device 4 is made of reinforced polymeric material, the reinforcement fibres are selected from the group comprising: glass fibres, aramidic fibres and carbon fibres.

Preferably, said polymeric material is a thermosetting material, and more preferably it is a thermosetting resin.

According to an alternative embodiment, the joining device is made of metallic material, preferably aluminium.

The panel 3 made of pre-insulated material is provided with fixing countermeans adapted to be engaged in a removable manner with the fixing means 8 associated with the joining device 4.

Said fixing countermeans comprise grooves 7, obtained at the end portions 2 of the panel 3.

As observable in FIG. 1c, such grooves 7 are made in the thickness of the panel 3.

The panel 3 made of pre-insulated material comprises at least one weakening line 16. In particular, in the first embodiment, the weakening lines are seven, in such a manner to allow the manufacture of a duct with an octagonal section.

Additionally, it comprises at least one external layer 9 and one insulating layer 10.

As visible in FIGS. 1a-1e, the panel 3 comprises an external layer 9, an internal layer 11 and an insulating layer 10 interposed between said external layer 9 and said internal layer 11.

The external layer 9 and/or internal layer 11 preferably comprises aluminium.

On the contrary, the insulating layer 10 comprises at least one of the materials selected form the group comprising: expanded polyurethane, expanded polyisocyanurate, phenolic foam, mineral wools.

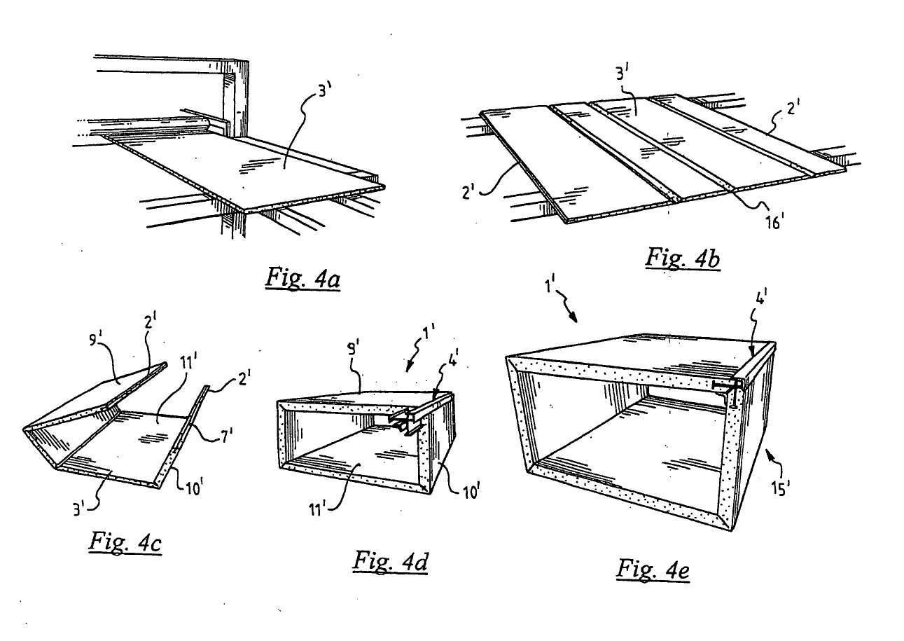

In the following description and in FIGS. 3 and 4a-4e, the joint system elements, of the joining device and panel according to the second embodiment of the invention which are structurally or functionally equal to the ones illustrated previously with reference to the first embodiment will be indicated by analogous reference numbers provided with an apex.

According to the second embodiment of the invention, shown in FIGS. 3 and 4a-4e, the angles α, β and γ are approximately 45°, in such a manner that the two panels 3′ connected by the joining element 4′ are perpendicular, and the duct 15′ thus formed is rectangular. For this reason, the weakening lines 16′ made in the panel 3′ are three.

FIGS. 1e and 4e show ducts 15; 15′ for air-conditioning systems comprising:
a panel 3; 3′ made of pre-insulated material as described previously; and
a joining element 4; 4′ as described previously.

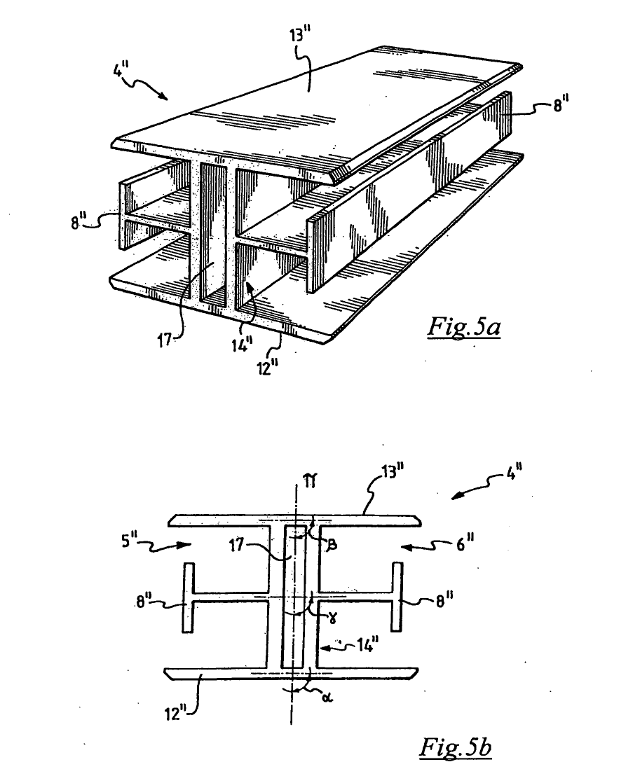

In the following description and in FIGS. 5a and 5b, the joint system elements according to the third embodiment of the invention which are structurally or functionally equal to the ones illustrated previously with reference to the first and second embodiment will be indicated with analogous reference numbers provided with two apexes.

According to such third embodiment of the invention, the angles α, β and γ are arranged at approximately 90°, in such a manner that the two panels connected by the joining element 4″ are coplanar.

Furthermore, according to this last embodiment, the joining device 4″ is provided with housing means of an angular element not shown in the figures. Said housing means preferably comprise a gap 17 adapted for the insertion of corresponding connection means of said angular element.

Through such angular element, it is possible to connect two joining devices, whose longitudinal centreline planes π are not parallel to each other, when it is required by construction needs.

In addition, said angular element has the purpose of strengthening the duct comprising such joining devices 4, 4′, 4″.

Following is the description of a preferred embodiment of the method of manufacturing panels 3 made of pre-insulated material for manufacturing ducts 15 for air-conditioning systems.

According to such embodiment, the method of manufacturing panels 3 comprises the steps of:
providing at least one panel 3 made of pre-insulated material;
providing the panel 3 with fixing countermeans adapted to be engaged in a removable manner with respective fixing means 8 associated with a joining device 4 as described previously.

In particular, the step of providing the panel 3 with fixing countermeans comprises the operation of performing grooves 7 at the end portions 2 of the panel 3.

Said grooves 7 are obtained in the thickness of the panel 3.

In addition, said method comprises the step of performing at least one weakening line 16 in the panel 3.

In particular, in the preferred embodiment, such method comprises the operation of performing seven weakening lines 16 on the panel 3, in such a manner to obtain a panel for manufacturing a duct 15 with an octagonal section.

According to a second embodiment, the method of manufacturing panels 3′ comprises the operation of performing three weakening lines 16′ in the panel 3′, in a manner to obtain panel 3′ for manufacturing a duct 15′ with a quadrangular section.

With special reference to FIGS. 1a-1e, will be now described a preferred embodiment of a method of joining the ends of the panel 3 made of pre-insulated material.

According to the preset invention, the method comprises the steps shown respectively in FIGS. 1a and d of:
a. preparing at least one panel 3 made of pre-insulated material as described previously;
b. nearing the opposite end portions 2 of said panel 3 and joining them by means of at least one joining device 4, as described previously.

FIGS. 4a-4d show the same method implemented on a panel of a different type through analogous means.

With reference to the same FIGS. 1a-1e, will be now described a preferred embodiment of a method of manufacturing ducts 15 for air-conditioning systems. Said method, according to said embodiment of the invention, comprises the steps of:
i. providing at least one panel 3 made of pre-insulated material as described previously;
ii. nearing the end portions 2 of said panel 3 and joining them by means of at least one joining device 4, as described previously in such a manner to form a duct 15.

According to an alternative embodiment, the method of manufacturing a duct 15 for air-conditioning systems, comprises the steps of:
i′. providing a panel 3 made of pre-insulated material provided with at least one weakening line 16 as described previously;
ii′. suitably bending the panel 3 following the bending direction substantially transverse to the weakening lines 16;
iii′. nearing the end portions 2 of said panel 3 and joining them by means of at least one joining device 4, as described previously in such a manner to form a duct 15.

Upstream step ii′, it is possible to provide the step of:
applying an amount of glueing agent at the weakening lines 16.

FIGS. 4a-4d show the same method implemented on a panel of different type through analogous methods.

The embodiments of the joint system, the joining device, the panel and the duct and the embodiments of the related methods of manufacturing the panels, panel joints and manufacturing of ducts herein described and illustrated, are illustrative and non-limiting examples of the invention. Variants and/or modifications can be performed on them by men skilled in the art without departing from the protection scope of the patent.

1-57. (canceled)

58. A duct for air-conditioning systems, comprising:
i) at least one panel made of pre-insulated material, and
ii) at least one joining device joining longitudinal end portions of said at least one panel,
wherein the joining device comprises:
a first and second longitudinal seats formed at opposite parts of a longitudinal center line plane of the joining device, each of said seats housing a respective longitudinal end portion of said at least one panel, and
fixing means for fixing the joining device to the longitudinal end portions of the panel, said fixing means being engaged in a removable manner with respective fixing countermeans associated to the longitudinal end portions of said at least one panel.

59. A duct according to claim 58, wherein:
the joining device comprises a radially internal shaped guide flap and a radially external shaped guide flap extending astride the longitudinal centreline plane of the joining device,
the guide flaps are connected to each other by means of at least one central body of the joining device, and
the guide flaps and said at least one central body of the joining device define the first and second longitudinal seats housing the longitudinal end portions of said at least one panel.

60. A duct according to claim 59, wherein said guide flaps comprise two semi-portions of shaped guide flap, said semi-portions being symmetrically arranged with respect to the longitudinal centreline plane of the joining device and forming respective angles α and β with said plane.

61. A duct according to claim 60, wherein said angles α and β are substantially equal to each other.

62. A duct according to claim 60, wherein angle α is comprised between 20° and 90°.

63. A duct according to claim 60, wherein angle β is comprised between 20° and 90°.

64. A duct according to claim 58, wherein said fixing means comprises at least two fixing flaps rigidly connected to at least one central body of the joining device and wherein said fixing flaps form an angle γ with the longitudinal centreline plane of the joining device.

65. A duct according to claim 64, wherein said angle γ is substantially equal to α and β.

66. A duct according to claim 64, wherein said angle γ is comprised between 20° and 90°.

67. A duct according to claim 64, wherein said fixing flaps are substantially T-shaped.

68. A duct according to claim 58, wherein the joining device further comprises housing means for housing connecting means of an angular element connecting together two joining devices.

69. A duct according to claim 68, wherein said housing means comprises a gap formed in the joining device.

70. A duct according to claim 58, wherein said joining device is made of polymeric material or metallic material.

71. A duct according to claim 70, wherein said polymeric material is selected from: polyvinyl chloride, nylon, polymeric material reinforced with reinforcement fibres.

72. A duct according to claim 70, wherein said polymeric material comprises a thermosetting resin.

73. A duct according to claim 58, wherein said fixing countermeans comprises a groove foamed at the longitudinal end portions of the panel.

74. A duct according to claim 73, wherein said grooves are formed in the thickness of the panel.

75. A duct according to claim 58, wherein said at least one panel comprises at least one weakening line.

76. A duct according to claim 58, wherein said at least one panel comprises at least one external layer and one insulating layer.

77. A duct according to claim 58, wherein said at least one panel comprises an external layer, an internal layer and one insulating layer interposed therebetween.

78. A duct according to claim 77, wherein at least one among said external layer and said internal layer comprises aluminum.

79. A duct according to claim 76, wherein said insulating layer comprises a material selected from: expanded polyurethane, expanded polyisocyanurate, phenolic foam, mineral wools.

80. A method of manufacturing a duct for air-conditioning systems, comprising:
i) providing at least one panel made of pre-insulated material,
ii) providing at least one joining device comprising:
a first and second longitudinal seats formed at opposite parts of a longitudinal center line plane of the joining device, each of said seats being adapted to house a respective longitudinal end portion of said at least one panel, and
fixing means for fixing the joining device to the longitudinal end portions of the panel, said fixing means being adapted to be engaged in a removable manner with respective fixing countermeans associated to the longitudinal end portions of said at least one panel,
iii) nearing the longitudinal end portions of said at least one panel, and
iv) joining together the longitudinal end portions of said at least one panel by means of said at least one joining device to form the duct.

81. A method according to claim 80, wherein:
the joining device comprises a radially internal shaped guide flap and a radially external shaped guide flap extending astride the longitudinal centreline plane of the joining device,
the guide flaps are connected to each other by means of at least one central body of the joining device, and
the guide flaps and said at least one central body of the joining device define the first and second longitudinal seats housing the longitudinal end portions of said at least one panel.

82. A method according to claim 81, wherein said guide flaps comprise two semi-portions of shaped guide flap, said semi-portions being symmetrically arranged with respect to the longitudinal centreline plane of the joining device and forming respective angles α and β with said plane.

83. A method according to claim 82, wherein said angles α and β are substantially equal to each other.

84. A method according to claim 80, wherein said fixing means comprises at least two fixing flaps rigidly connected to at least one central body of the joining device and wherein said fixing flaps form an angle γ with the longitudinal centreline plane of the joining device.

85. A method according to claim 84, wherein said angle γ is substantially equal to α and β.

86. A method according to claim 84, wherein said fixing flaps are substantially T-shaped.

87. A method according to claim 80, further comprising inserting connecting means of an angular element into housing means formed in the joining device for connecting together two joining devices.

88. A method according to claim 87, wherein said housing means comprises a gap adapted for the insertion of said connecting means of the angular element.

89. A method according to claim 80, wherein said fixing countermeans comprises a groove formed at the longitudinal end portions of the panel.

90. A method according to claim 89, wherein said groove is formed in the thickness of the panel.

91. A method according to claim 80, wherein said at least one panel comprises at least one weakening line.

92. A method according to claim 91, further comprising bending the panel following a bending direction substantially transverse to the weakening lines.

93. A method according to claim 92, further comprising applying an amount of glueing agent at the weakening lines before bending the panel.
